(19) United States
(12) Patent Application Publication
(10) Pub. No.: US 2013/0264203 A1
(43) Pub. Date: Oct. 10, 2013

(54) LOW COST CO-FIRED SENSOR HEATING CIRCUIT

(71) Applicants: Oscar Gamboa, Gomez (MX); Walter T. Symons, Grand Blanc, MI (US); Eric P. Clyde, Metamora, MI (US); Kaius K. Polikarpus, Grand Blanc, MI (US); Debabrata Sarkar, Rochester, MI (US)

(72) Inventors: Oscar Gamboa, Gomez (MX); Walter T. Symons, Grand Blanc, MI (US); Eric P. Clyde, Metamora, MI (US); Kaius K. Polikarpus, Grand Blanc, MI (US); Debabrata Sarkar, Rochester, MI (US)

(73) Assignee: DELPHI TECHNOLOGIES, INC., TROY, MI (US)

(21) Appl. No.: 13/701,638

(22) PCT Filed: Jun. 4, 2011
(86) PCT No.: PCT/US11/39194

§ 371 Date: Jun. 17, 2013

Related U.S. Application Data
(60) Provisional application No. 61/351,348, filed on Jun. 4, 2010.
(60) Provisional application No. 61/351,396, filed on Jun. 4, 2010.

(51) Int. Cl. G01N 27/406; H05B 3/18

(52) U.S. Cl. CPC G01N 27/4067; H05B 3/18
USPC 204/424; 219/544

(57) ABSTRACT

A planar device includes a heating circuit that is disposed between ceramic layers and co-fired with the ceramic. The heating circuit comprises palladium, and the co-firing of the palladium and ceramic is performed in an oxidizing atmosphere. The formation of defects in the planar device that would otherwise be induced as a result of the palladium oxidizing during the co-firing process is prevented by control of the firing profile, by the geometry of the pattern of the heating circuit, and/or by modifying the palladium to reduce its tendency to oxidize.

### CROSS REFERENCE TO RELATED APPLICATIONS

This application claims priority to U.S. Provisional Application Ser. No. 61/351,348, filed Jun. 4, 2010, the contents of which are hereby incorporated by reference. This application additionally claims priority to U.S. Provisional Application Ser. No. 61/351,396, filed Jun. 4, 2010, the contents of which are hereby incorporated by reference.

### TECHNICAL FIELD

The present disclosure relates to a palladium heating circuit in a co-fired planar device.

### BACKGROUND OF THE INVENTION

Current planar oxygen sensors use ceramic tapes and precious metal circuits to form a sensor structure. Tapes (ceramic substrates) include insulating materials (alumina or zirconia) and an electrolyte (zirconia) in addition to metallizations to form functional Nernst cell exhaust sensors. Such planar devices are formed as multi-layer co-fired ceramic circuits, where all components are assembled in “green” (unfired) state, laminated to form a contiguous structure, and co-fired at temperatures appropriate for densification of ceramic body and formation of a monolithic structure after sintering. Due to the high sintering temperatures required for the ceramic substrates (1400°-1600° C.), metallization is limited to PGM (Platinum Group Metals) materials. Exhaust Oxygen sensors typically use platinum for the heater circuit in the co-fired device. Application of alternative metallurgy is limited by the high sintering temperatures (precluding metals such as silver), the requirement for oxidizing atmosphere during sintering zirconia (precluding materials such as tungsten), and cost (precluding materials such as rhodium). Palladium has been considered for such applications, but its use is limited due to oxidation and associated volume expansion during the sintering process. Platinum has a TCR (Thermal Coefficient of Resistance) of around 3850 ppm/K. This value of TCR gives Pt heater circuits a very specific electrical signature. Palladium also has a very similar TCR as that of the platinum and has similar electrical properties. The successful use of palladium for a heater circuit would represent a significant material cost advantage for planar exhaust sensors with almost no changes in electrical signature compared to platinum.

Accordingly, a need exists in the sensor art for sensors that successfully overcome the oxidation and volume expansion problems associated with palladium, allowing palladium to be used in a sensor heating circuit.

### SUMMARY

Disclosed herein is a co-fired planar sensor comprising a palladium heater circuit. The sensor is manufactured using a sintering time and temperature profile that allows for densification of the ceramic elements in the sensor without the palladium material in the heater circuit experiencing oxidation and volume expansion to an extent that results in delamination of the ceramic layers that comprise the sensor. The palladium heater circuit is further configured such that sufficiently low stresses are applied to the structure during the sintering process that internal defects are avoided.

The above described and other features are exemplified by the following figures and detailed description.

### BRIEF DESCRIPTION OF THE DRAWINGS

Refer now to the Figures, wherein like elements are numbered alike.

FIG. 1 is an exploded isometric view of an oxygen sensing element.

FIG. 2 is a thermogram from a TGA analysis of palladium powder in air.

### DETAILED DESCRIPTION

At the outset of the description, it should be noted that the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced items. The modifier “about” used in connection with a quantity is inclusive of the stated value and has the meaning dictated by the context (e.g., includes the degree of error associated with measurement of the particular quantity). It is noted that the terms “bottom” and “top” are used herein, unless otherwise noted, merely for convenience of description, and are not limited to any one position or spatial orientation. Furthermore, all ranges disclosed herein are inclusive and combinable (e.g., ranges of “up to about 25 weight percent (wt. %), with about 5 wt. % to about 20 wt. % desired, and about 10 wt. % to about 15 wt. % more desired,” are inclusive of the endpoints and all intermediate values of the ranges, e.g., “about 5 wt. % to about 25 wt. %, about 5 wt. % to about 15 wt. %”, etc.). Finally, unless defined otherwise, technical and scientific terms used herein have the same meaning as is commonly understood by one of skill in the art to which this invention belongs. The suffix “(s)” as used herein is intended to include both the singular and the plural of the term that it modifies, thereby including one or more of that term (e.g., the metal(s) includes one or more metals).

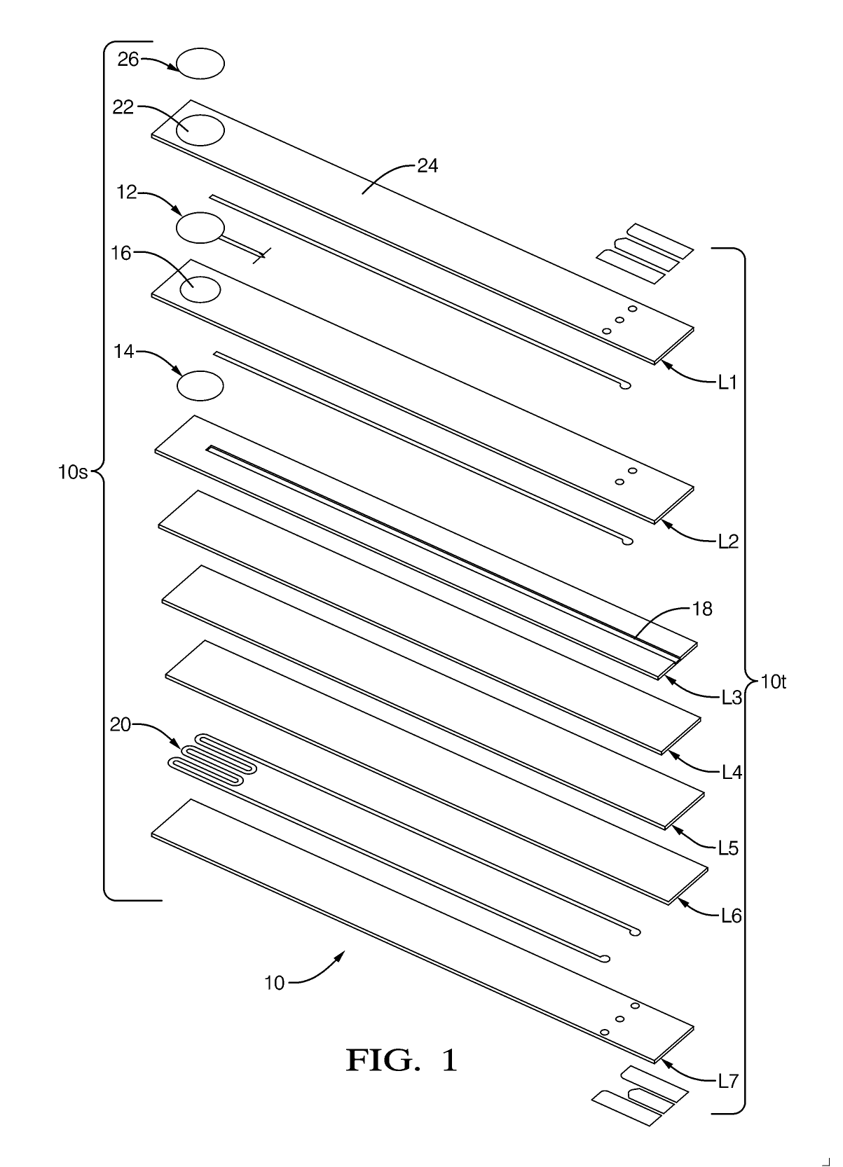

An exemplary planar oxygen-sensing element 10 is shown in FIG. 1. As shown in FIG. 1, sensing element 10 can comprise a sensing end 10s and a terminal end 10t. The sensing element 10 can comprise a sensing (i.e., first, exhaust gas, or outer) electrode 12, a reference gas (i.e., second or inner) electrode 14, and an electrolyte portion 16. The electrolyte portion 16 can be disposed at the sensing end 10s with the electrodes 12, 14 disposed on opposite sides of, and in ionic contact with, the electrolyte portion 16, thereby creating an electrochemical cell (12/16/14).

A reference gas channel 18 can be disposed on the side of the reference electrode 14 opposite the electrolyte portion 16. The reference gas channel 18 can be disposed in fluid communication with the reference electrode 14 and with a reference gas (e.g., the ambient atmosphere or another gas supply).

A heater 20 can be disposed on a side of the reference gas channel 18 opposite the reference electrode 14, for maintaining sensing element 10, and in particular, the sensing end 10s of the sensing element, at a desired operating temperature. The heater 20 can be disposed on one of the support layers by various methods such as, for example, screen-printing.

A protective layer L1 can be disposed adjacent to the sensing electrode 12 opposite the electrolyte portion 16. The protective layer L1 can comprise a solid portion 24 and a porous portion 22 disposed adjacent to the sensing electrode 12. The porous portion 22 can be a material that enables fluid communication between the sensing electrode 12 and the gas to be sensed. For example, the porous portion 22 can comprise a porous ceramic material formed from a precursor comprising a ceramic (e.g., spinel, alumina, zirconia, and/or the like), a fugitive material (e.g., carbon black), and an organic binder. The fugitive material can provide pore formation in the fired layer. The porous portion 22 can be formed, for example, from a precursor comprising about 70 to about 80 weight percent (wt. %) of one or more of the foregoing ceramic materials, about 5 to about 10 wt. % of the fugitive material, and about 15 wt. % to about 20 wt. % of an organic binder, based upon the total weight of the precursor, which can be applied using various methods including thick film methods, and the like, followed by sintering.

In order to further protect the sensing electrode 12, a protective coating 26 can optionally be disposed over the porous portion 22 and optionally over layer L1. As with the porous portion 22, at least in the area of the porous portion 22, the protective coating 26 allows fluid communication between the sensing electrode 12 and the gas to be sensed. Possible materials for the protective coating 26 can comprise spinel, alumina (e.g., stabilized alumina), and other protective coatings employed in sensors.

If desired, one or more support layers can be disposed on a side of the sensing electrode 12 opposite the electrolyte 16; between the reference gas channel 18 and the heater 20, and on a side of the heater 20 opposite the reference gas channel 18. As shown, insulating layer L1 is disposed on a side of the sensing electrode 12 opposite the electrolyte portion 16; support layers L3-L6 are disposed between the reference electrode 14 and the heater 20; and support layer L7 is disposed on a side of the heater 20 opposite the reference gas channel 18. A support layer L2 can be employed with the electrolyte 16 disposed therethrough, attached to an end thereof, or the electrolyte can comprise the entire layer.

The support layers, e.g., L2-L7, that can provide structural integrity (e.g., protect various portions of the gas sensor from abrasion and/or vibration, and the like, and provide physical strength to the sensor); physically separate and electrically isolate various components; and provide support for various components that can be formed in or on the layers. Depending on the arrangement, the support layers can each comprise the same or different materials, e.g., a dielectric material (e.g., alumina (Al₂O₃)), an electrolytic material (e.g., zirconium oxide (zirconia)), protective material, and the like. Each of the support layers can comprise a thickness of up to about 500 micrometers so, depending upon the number of layers employed, or, more particularly, about 50 micrometers to about 200 micrometers. Although illustrated herein as comprising seven layers L1-L7, it should be understood that the number of layers could be varied depending on a variety of factors.

Electrolyte portion 16 can comprise a solid electrolyte. The electrolyte portion 16 can be disposed through layer L2 in a variety of arrangements. For example, the entire layer L2 can be formed of electrolyte material 16. Alternatively, the electrolyte portion 16 can be attached to L2 at the sensing end such that the electrolyte portion 16 forms the sensing end of L2, disposed in an aperture (not illustrated) adjacent to the sensing end 10s, and disposed in an opening through the layer L2. The latter arrangement eliminates the use of excess electrolyte. Any shape can be used for the electrolyte, with the size and geometry of the various inserts, and therefore the corresponding openings, being dependent upon the desired size and geometry of the adjacent electrodes. The openings, inserts, and electrodes can comprise a substantially compatible geometry such that sufficient exhaust gas access to the electrode(s) is enabled and sufficient ionic transfer through the electrolyte is established to attain the desired sensor function. The electrolyte can comprise a thickness of up to about 500 micrometers or so, more specifically, about 25 micrometers to about 500 micrometers, and even more specifically, about 50 micrometers to about 200 micrometers.

The electrolyte 16 can be, for example, any material that is capable of permitting the electrochemical transfer of oxygen ions while inhibiting the passage of exhaust gases, desirably has an ionic/total conductivity ratio of approximately unity, and is compatible with the environment in which the sensor will be utilized. Possible electrolyte materials can comprise any material capable of functioning as a sensor electrolyte including, but not limited to, zirconium oxide (zirconia), cerium oxide (ceria), calcium oxide, yttrium oxide (yttria), lanthanum oxide, magnesium oxide, ytterbium (III) oxide (Yb₂O₃), scandium oxide (Sc₂O₃), and so forth, as well as combinations comprising at least one of the foregoing. If zirconia is employed, it can be stabilized with, for example, with calcium, barium, yttrium, magnesium, aluminum, lanthanum, cesium, gadolinium, and so forth, as well as combinations comprising at least one of the foregoing materials. For example, the electrolyte can be alumina stabilized zirconia and/or yttrium stabilized zirconia.

Accordingly, formation of electrically conductive element(s) of the sensing element 10 can comprise preparing a suitable precursor material such as an ink, paste, slurry and/or the like. For example, a precursor (ink) can be formed by mixing a metal powder with a sufficient quantity of an organic vehicle to attain the desired adhesion to the substrate after firing, as well as other properties.

Optionally, the precursor material can comprise a metal oxide, for example, to improve the adhesion of the electrically conductive element(s) to underlying substrate (where applicable), and/or impart beneficial properties such as inhibition of further sintering. Possible metal oxides can comprise ceria, lanthana, magnesia, zirconia, yttria, alumina, scandia, and the like, and mixtures comprising at least one of the foregoing. The amount of metal oxide employed is dependent upon the particular metals employed and the temperatures used in forming the sensor. The metal powder and optional metal oxide can be combined with a vehicle (e.g., an organic vehicle) to enable deposition of the precursor onto the desired portion(s) of the sensor element.

Once prepared, the conductive element precursor material can be applied to the desired area of the sensor, using various application technique(s) such as thick film technique(s) including screen printing, painting, spraying, dipping, coating, and the like. Depending upon the particular electrically conductive element, as well as the particular technique employed, optional thickener(s), binder(s), additive(s), fugitive material(s) (e.g., carbon, insoluble organic material, and the like), and so forth (hereinafter additive(s)), can be employed in the precursor material in an amount of less than or equal to about 40 wt. % additives for screen printing, less than or equal to about 60 wt. % additives for pad flexing (painting), less than or equal to about 75 wt. % additives for spray coatings, less than or equal to about 90 wt. % additives for dip coatings, based on the total weight of thick film inks. Possible additives include: 1-ethoxypropan-2-ol, turpentine, squeegee medium, 1-methoxy-2-propanol acetate, butyl acetate, dibutyl phthalate, fatty acids, acrylic resin, ethyl cellulose, pine oil, 3-hydroxy, 2,2,4-trimethylpentyl isobutyrate, terpineol, butyl carbitol acetate, cetyl alcohol, cellulose ethylether resin, and so forth, as well as combinations comprising at least one of the foregoing.

The thickness of the electrically conductive elements (e.g., the leads, the heater, the contact pads, temperature sensor, the vias, and other electrically conductive components) is dependent upon the particular element. The thickness can be up to the thickness of the layer or so (e.g., for a via), or, more particularly, about 1 micrometers (μm) to about 50 micrometers, or, even more particularly, about 3 micrometers to about 35 micrometers, and still more particularly about 7 micrometers to about 25 micrometers.

Furthermore, the element precursor material can be applied during any point during the manufacturing process; i.e., before the substrate is fired (green), before the substrate is fully fired (bisque), or after the substrate is fully fired. In each case, once the element precursor material has been applied, the substrate is heated to a temperature sufficient to sinter the precursor material (e.g., greater than or equal to about 1450° C. for about 2 hours). Optionally, the electrically conductive elements can be co-fired with green layers (alumina (Al₂O₃), zirconia (ZrO₂), and so forth). For a coating comprising a metal oxide such as zirconia, alumina, for example, temperatures of about 1,400° C. or greater can be employed.

The foregoing sensor, and others comprising a different number of cells, can be formed using a variety of methods in which the components can be formed and fired separately or formed (optionally laminated), and co-fired. For example, an electrolyte tape can be formed and partially fired to the bisque state. The precursor material can be prepared as described above and deposited on the appropriate portions of the support layer(s) and/or the electrolyte tape and connecting electrical leads to the ink. A protective layer and support layer(s) can be disposed accordingly, with a temperature sensor (not shown) and/or heater disposed therein as desired. The lay-up can then be heated to a sufficient temperature to volatilize the organics and to sinter the metals in the precursor, thereby forming the sensor.

To form an exhaust sensor, the sintering of the zirconia must be performed in an oxidizing atmosphere. While this does not present any particular issues with the electrically conductive elements (e.g., the leads, the heater, the contact pads, temperature sensor, the vias, and other electrically conductive components) formulated from platinum, palladium has other properties that preclude simply substituting palladium for platinum in the sensor.

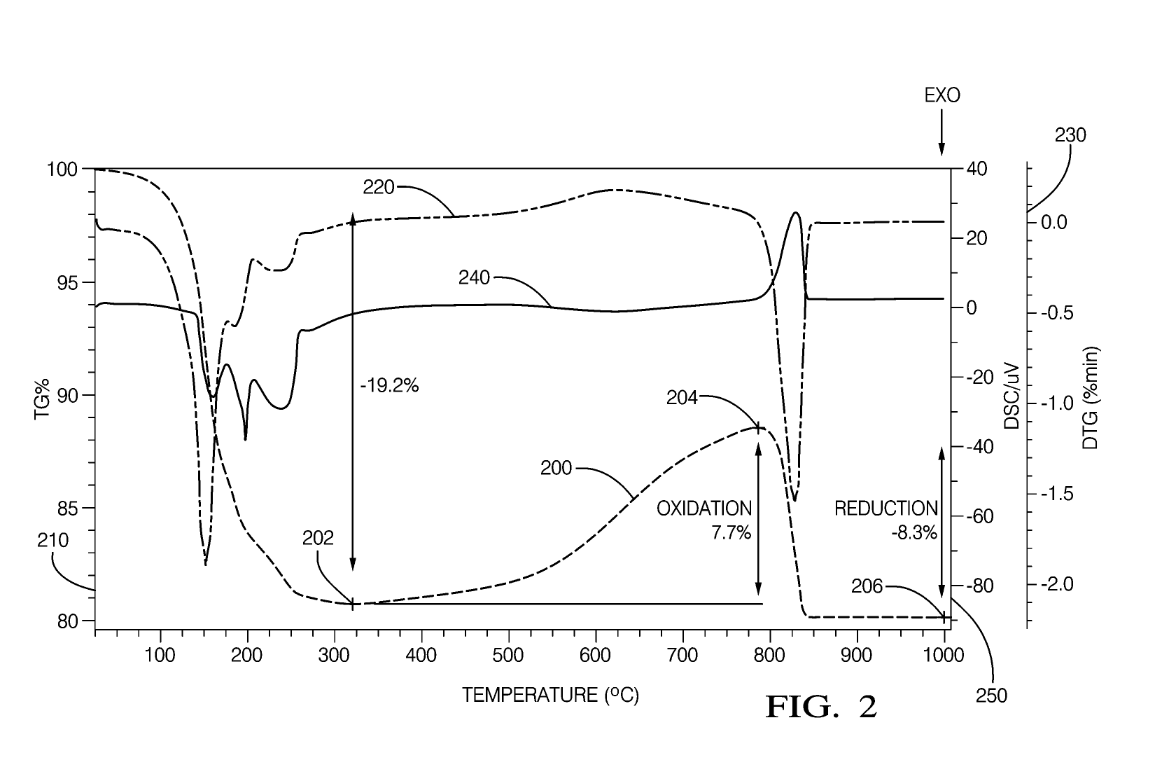

FIG. 2 shows a thermogram from a TGA (thermogravimetric analysis) of a sample of palladium ink. The TGA was performed in air. In FIG. 2, trace 200 represents the weight of the sample as a percentage of its initial weight, plotted against the “TG %” scale represented on axis 210. Trace 220 represents the derivative of the percent weight change trace 200, plotted against the “DTG (%/min)” scale represented on axis 230. Trace 240 represents the heat flow in the sample, plotted against the “DSC uV” scale represented on axis 250.

Point 202 on trace 200 represents a local minimum weight measured at a temperature of approximately 320 C. This point 202 represents the weight reduction due to the removal of organic binders in the ink. At point 202, the sample has lost 19.2% of its initial weight.

As the temperature is increased beyond the temperature represented by point 202, trace 200 shows a weight gain to a local maximum at point 204. This local maximum represented by point 204 occurs at a temperature of approximately 800 C. The weight gain from point 202 to point 204 represents 7.7% of the original sample weight, and results from oxidation of the palladium in the ink sample.

As the temperature is further increased beyond the temperature represented by point 204, trace 200 shows a weight decrease due to reduction of the oxidized palladium to unoxidized metallic palladium. Point 206 represents the weight change at the maximum temperature analyzed (1000 C). The weight loss of the sample from the local maximum at point 204 to the final value at point 206 represents 8.3% of the original sample weight, and the total weight loss from the initial weight of the sample to the final value at point 206 represents 19.8% of the total sample weight, due primarily to the removal of the organic binders in the initial sample. From this result, it can be concluded that the palladium ink sample had approximately 80% solids content.

The information from the TGA plot in FIG. 2 can be related to practical considerations with respect to a sensor heater circuit. The oxidation that is evidenced by the weight gain in the vicinity of point 204 in FIG. 2 also causes volume expansion of the palladium by about 30%. This volume expansion may result in stresses during sintering of a co-fired planar sensor structure that can cause internal defects in the sensor. An example of such a defect is delamination between layers of the sensor, resulting in a void in what should be a monolithic structure. The temperature at which the TGA plot in FIG. 2 shows oxidation of palladium exposed to air is comparable to the operating temperature of a heater in an exhaust sensor. If the hermetic isolation between the heater and the atmosphere is not maintained, for example as a result of a void or delamination extending from the heater to an exposed edge of the sensor, oxidation of the palladium may occur during use of the sensor. Such oxidation can result in a change in the electrical properties of the heater and/or catastrophic destruction of the heater.

It has been discovered that improvements in forming co-fired monolithic sensors with embedded palladium may be realized in several ways. The palladium powder used in the precursor material used to form the heater may be modified in such a way as to reduce its propensity to oxidize. Such modifications may include alloying another element, for example rhodium, with the palladium. Another modification may relate to the morphology (e.g. particle shape, particle surface area) of the palladium powder. Further disclosure of potential palladium modifications may be found in U.S. Patent Application Publication 2007/0108047, the contents of which are hereby incorporated by reference. It has been found that using a modified palladium composition that is less prone to oxidation results in the ability to form co-fired sensors with reduced voids and delamination.

It has also been found that the occurrence of voids and delamination can be decreased by modifying the firing profile used to co-fire the sensor structure. More particularly, it has been found that decreasing the time rate of change of temperature at least in the region associated with oxidation of palladium (e.g. temperatures from approximately 400° C. to approximately 850° C.) can result in improved co-fired structures. Without being bound to a theory, it is believed that the ceramic layers adjoining the palladium heater have not yet densified at this temperature, and are able to better accommodate stresses induced by the volumetric expansion of oxidizing palladium as long as the rate of application of the stress (i.e. the rate of volumetric expansion, which relates to the rate of oxidation) is held sufficiently small. It is also believed that limiting the rate of temperature change in the temperature region associated with the reduction of oxidized palladium to non-oxidized palladium (i.e. temperatures above the temperature corresponding to point 204 in FIG. 2) limits the rate of generation of gaseous oxygen liberation from the oxidized palladium. By limiting the rate of oxygen generation to a sufficiently low level, the generated oxygen is allowed to diffuse through the as yet non-densified ceramic structure without introducing voids in the sensor structure.

Another factor that has been found to improve the ability to form durable co-fired sensors with palladium heaters is the percentage of solids in the precursor material used to form the palladium heater circuit. As previously mentioned, the palladium ink material used in the TGA analysis shown in FIG. 2 had approximately 80% solids content. Unexpectedly, it has been discovered that reducing the solids content of the palladium precursor material, for example to a range of 65% to 70% solids content, has been found to reduce the formation of voids and delamination in the co-fired sensor. Not to be bound to a theory, it may be that the reduced solids percentage (and hence increased volatiles percentage) in the precursor ink may result in additional spaces within the dried ink after the volatile components have been evaporated, and that these additional spaces may accommodate some degree of volumetric expansion of the palladium as it oxidizes while reducing the stress imparted on the surrounding ceramic layers.

It has been found that the ability to form durable co-fired sensors with palladium heaters is influenced by the geometry of the heater itself. More specifically, it has been found that minimizing the cross sectional area of the heater circuit assists in achieving a structure with sufficiently low stresses during the sintering process to avoid internal defects. In the exemplary exhaust sensor depicted in FIG. 1, it can be seen that after sintering the heater circuit 20 is sandwiched between layers L6 and L7, thereby forming a monolithic structure in which there is no discernible boundary between L6 and L7 except for the regions defined by the heater circuit. The term “land” area will be used herein to define the area on the surface of one layer of ceramic which is brought into direct contact with an adjacent ceramic layer without an intervening conductor layer. As disclosed earlier, the heater 20 can be disposed on one of the support layers by various methods such as, for example, screen-printing. For example, the entire surface of the support layer (e.g. L6 or L7) on which the heater 20 is disposed other than the area directly covered by the heater can be identified as the land area. It has been found that keeping the cross sectional area of the heater circuit small relative to the dimensions of the land areas between paths of the heater circuit can result in a structure with reduced occurrence of internal defects. More specifically, it has been found advantageous to define a heater structure with thin narrow lines having widths in the range of 0.1 to 0.25 mm, with a heater thickness of 0.01 to 0.03 mm, in the heater hot zone, that is, the area of the heater circuit that reaches the highest temperature when the heater is powered.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation of material to the teachings of the invention without departing from the essential scope thereof. Therefore, it is intended that the invention not be limited to the particular embodiments disclosed as including the best mode contemplated for carrying out this invention, but that the invention will include all embodiments falling within the scope of the appended claims.

What is claimed is:

1. A planar device comprising a heater circuit, said heater circuit formed by depositing a heater precursor material in a predetermined pattern on a surface of a first unfired ceramic substrate, laminating the first unfired ceramic substrate to a second unfired ceramic substrate with the heater precursor material in contact with the second unfired ceramic substrate to form a laminated combination, and firing the laminated combination in an oxidizing atmosphere for a sufficient time and to a sufficient temperature to densify the laminated combination into a densified ceramic structure;
wherein the heater precursor material comprises palladium;
wherein the process of firing the laminated combination raises the temperature of the laminated combination through the temperature range from 400° C. to 850° C. sufficiently slowly to prevent the formation of voids in the final densified ceramic structure in the vicinity of the heater pattern.

2. The planar device of claim 1, wherein the heater precursor material has a solids content of 65% to 70% by weight.

3. The planar device of claim 1, wherein the planar device is an oxygen sensor that further comprises a zirconia electrolyte.

4. The planar device of claim 1, wherein the heater precursor material comprises palladium that is modified to reduce the tendency of the palladium to oxidize.

5. The planar device of claim 4, wherein the heater precursor material comprises palladium powder that comprises palladium particles having a predefined shape or predetermined surface area that reduces the tendency of the palladium to oxidize.

6. The planar device of claim 4, wherein the heater precursor material comprises palladium that is alloyed with another metal that reduces the tendency of the palladium to oxidize.

7. The planar device of claim 6, wherein the palladium is alloyed with rhodium.

8. The planar device of claim 1, wherein the heater circuit has line widths of 0.1 mm to 0.25 mm in the area of the heater circuit that reaches the highest temperature when the heater circuit is electrically powered.
